(19) United States
(12) Patent Application Publication
(10) Pub. No.: US 2026/0264699 A1
(43) Pub. Date: Sep. 10, 2026

(54) SYSTEMS AND METHODS OF GENERATING SIMULATED DATASETS FOR DEVELOPING AUTONOMOUS VEHICLES

(71) Applicant: Torc Robotics, Inc., Blacksburg, VA (US)

(72) Inventors: Lili Gao, Fellbach (DE); Samuele Ruffino, Stuttgart (DE); Roger Girgis, Ile-Bizard (CA); Mario Bijelic, Frankfurt (DE); Felix Heide, New York, NY (US); Xue Yang, San Diego, CA (US); Julian Ost, Limburg (DE); Tonmoy Saikia, Freiburg im Breisgau (DE); Edoardo Palladin, Stuttgart (DE); Stefanie Walz, Geislingen/Steige (DE)

(21) Appl. No.: 19/070,410

(22) Filed: Mar. 4, 2025

(51) Int. Cl. B60W 50/00; B60W 60/00; G05B 13/02

(52) U.S. Cl. CPC B60W 50/00; B60W 60/00; G05B 13/0265; B60W 2050/0028; B60W 2554/00; B60W 2556/00

(57) ABSTRACT

A simulation generation computing device for developing an autonomy computing system of an autonomous vehicle is provided. The simulation computing device includes at least one processor in communication with at least one memory device. The at least one processor is programmed to receive a simulated dataset having one or more scenes of an environment in which an autonomous vehicle could operate, and sample the simulated dataset to obtain one or more samples of the simulated dataset. The at least one processor is further programmed to determine one or more quality scores corresponding to the one or more samples of the simulated dataset in comparison with a reference dataset. The at least one processor is also programmed to filter the simulated dataset based on the one or more quality scores to retain one or more quality samples, and output a quality simulated dataset including the one or more quality samples.

### TECHNICAL FIELD

The field of the disclosure relates generally to autonomous vehicles and, more specifically, to generating simulated datasets for developing autonomy computing systems in autonomous vehicles.

### BACKGROUND OF THE INVENTION

An autonomous vehicle relies on its autonomy computing system to perceive the environment in which the autonomous vehicle is operating or traveling, and plan and control the operation of the autonomous vehicle in the environment based on the perception. The autonomy computing system includes one or more machine learning models. In developing a machine learning model, development datasets are needed. Real-world datasets are of real-world scenarios and acquired by sensors of autonomous vehicles while the vehicles were driving in various scenarios and/or environments. Real-world datasets are limited, costly, and labor intensive to acquire. Further, real-world datasets on edge cases, such as erratic driving or accidents, are typically unavailable, and risky and costly to acquire by driving the vehicles in the environments hoping to experience such cases. Accordingly, it is desirable to provide systems and methods for generating simulated datasets for developing autonomy computing systems of autonomous vehicles.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a simulation generation computing device for developing an autonomy computing system of an autonomous vehicle is provided. The simulation computing device includes at least one processor in communication with at least one memory device. The at least one processor is programmed to receive a simulated dataset having one or more scenes of an environment in which an autonomous vehicle could operate, and sample the simulated dataset to obtain one or more samples of the simulated dataset. The at least one processor is further programmed to determine one or more quality scores corresponding to the one or more samples of the simulated dataset in comparison with a reference dataset. The at least one processor is also programmed to filter the simulated dataset based on the one or more quality scores to retain one or more quality samples, and output a quality simulated dataset including the one or more quality samples.

In another aspect, one or more non-transitory machine-readable storage media for generating simulated datasets for developing an autonomy computing system of an autonomous vehicle. The one or more non-transitory machine-readable storage media include a plurality of instructions stored thereon that, in response to being executed, cause a system to receive a simulated dataset having one or more scenes of an environment in which an autonomous vehicle could operate. The plurality of instructions further cause the system to sample the simulated dataset to obtain one or more samples of the simulated dataset, and determine one or more quality scores corresponding to the one or more samples of the simulated dataset in comparison with a reference dataset. The plurality of instructions further cause the system to filter the simulated dataset based on the one or more quality scores to retain one or more quality samples, and output a quality simulated dataset including the one or more quality samples.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle.

FIG. 2 is a block diagram of an autonomous vehicle.

FIG. 3A is a schematic diagram of an example simulation generation computing device for generating simulated data to be used in developing autonomous vehicles.

FIG. 3B is a schematic diagram of an example generation module of the simulation generation computing device shown in FIG. 3A.

FIG. 3C is schematic diagram illustrating a scene in a dataset.

FIG. 3D shows generation of simulated datasets.

FIG. 3E are frames in scenes generated by varying the environments in the scenes.

FIG. 4 is a flow chart of an example method of generating simulated datasets.

FIG. 5 is a block diagram of an example computing device.

FIG. 6 is a block diagram of an example user computing device.

FIG. 7 is a block diagram of an example server computing device.

FIG. 8 shows synthetic data validation and selection.

FIG. 9 shows dataset samples.

FIG. 10 shows layout conditioned generation.

FIG. 11 is a table showing evaluation of an example simulation generation method of DiffMentation for monocular three-dimensional (3D) object detection.

FIG. 12 is a table showing ablation Experiments on filtering and scenario generation modules.

FIGS. 13A and 13B show qualitative visualization of MonoRCNN detection results on test samples.

FIG. 14 is a table showing class-wise mAP results for MonoRCNN in comparison to baseline techniques.

FIG. 15 is a table showing ablation experiments evaluating the impact of different control layouts on the video generation module for MonoRCNN.

FIG. 16 is a table showing ablation experiments for different mix ratios of real and generated training samples.

FIG. 17 is a table showing number of instances for every class for real (7821 samples) and resampled generated dataset (18860 samples).

FIG. 18 are real and resampled generated dataset class distribution.

FIG. 19 are examples of randomly selected samples from the real-world dataset.

FIG. 20 are examples of randomly selected samples from the generated dataset.

FIG. 21 shows visualization of generated sequence examples.

FIGS. 22A-22C are visualization of generated sequences with diverse prompting for changing conditions.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods of generating simulated datasets for developing autonomous vehicles are provided. An autonomy computing system of an autonomous vehicle perceives the environment in which the autonomous vehicle operates. An autonomy computing system includes one or more machine learning models. A relatively large amount of data is needed in developing the machine learning models to limit the underfitting and overfitting of the machine learning models, thereby increasing the capability of the autonomy computing system in operating in real-world driving environments. Real-world datasets are costly and time consuming to obtain. Real-world datasets are also not readily available, especially edge cases. Simulated datasets are advantageous in these aspects, compared to the real-world datasets. However, a simulated dataset is not necessarily suitable for developing autonomous vehicle to handle real-world driving environments if the simulated dataset does not resemble the real-world driving. However, a simulated dataset loses its advantages if the simulated dataset is too close to the real-world datasets.

Systems and methods described herein address the problems with simulated datasets using a quality score and a diversity score to select quality, diverse samples from a simulated dataset. Systems and methods described herein are also configured to augment simulated datasets, thereby increasing the amount of data in simulated datasets. Simulated datasets are augmented by varying agent layouts in the driving scenarios. Agents are actors in an environment, such as vehicles with or without autonomous driving capability, pedestrians, or cyclist. Agents are used to control behavior of individual actors in the environment. Additionally or alternatively, simulated datasets are augmented by varying the environments in which an autonomous vehicle could operate.

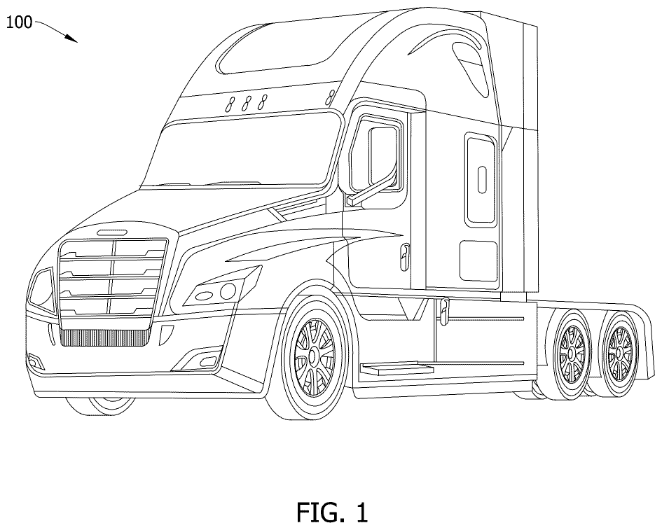

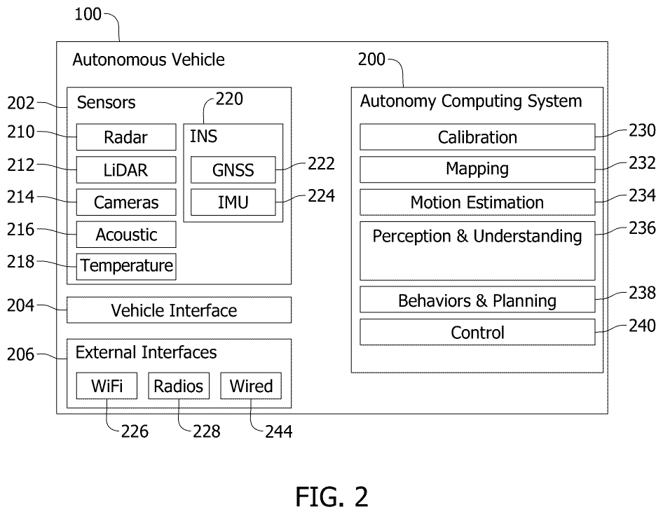

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 may include RGB cameras, which are configured to capture images based on visible light. Cameras 214 may further include a gated camera, such as gated near infrared (NIR) camera. A gated camera is configured to capture images based on invisible light, such as NIR light. Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

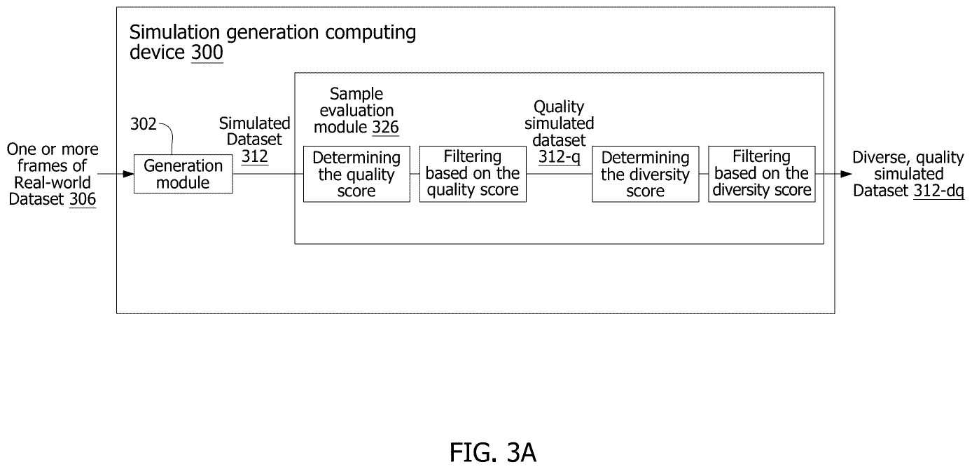

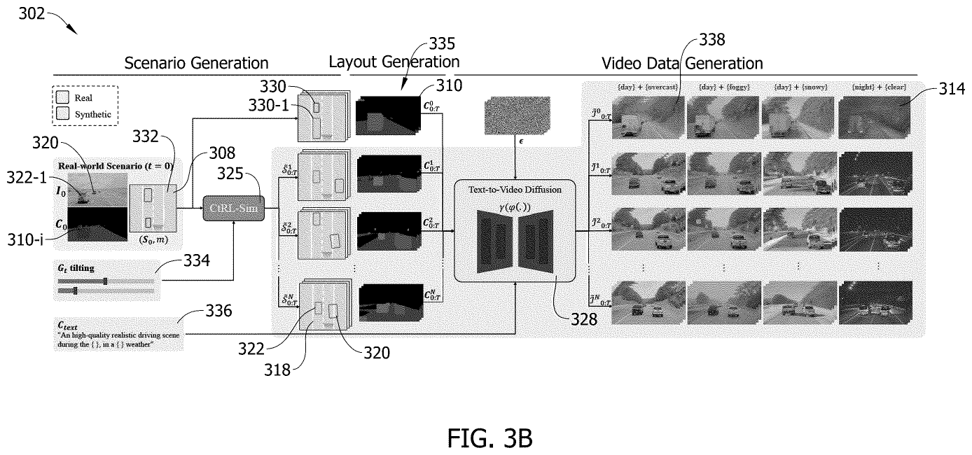

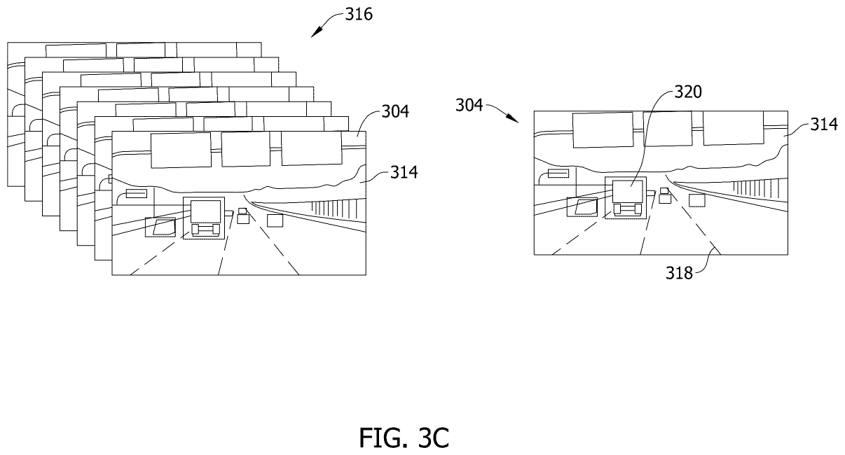

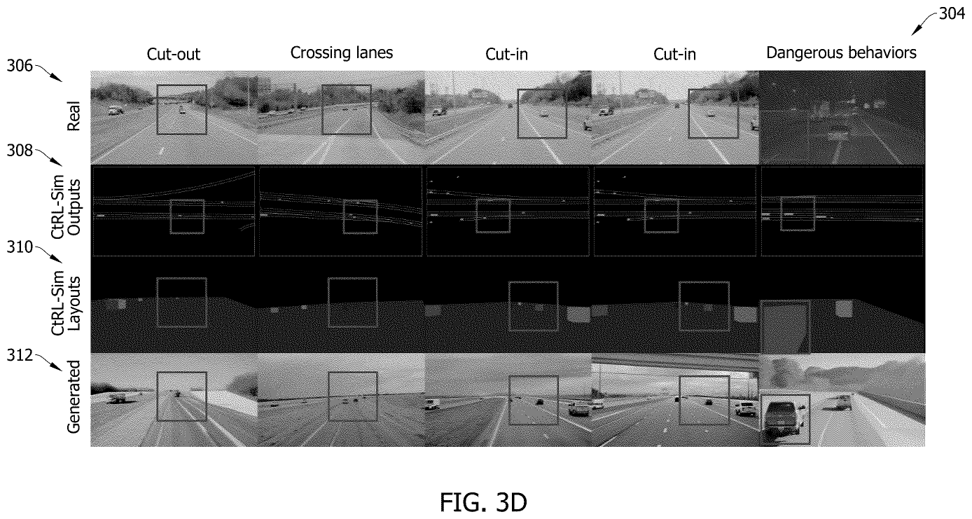

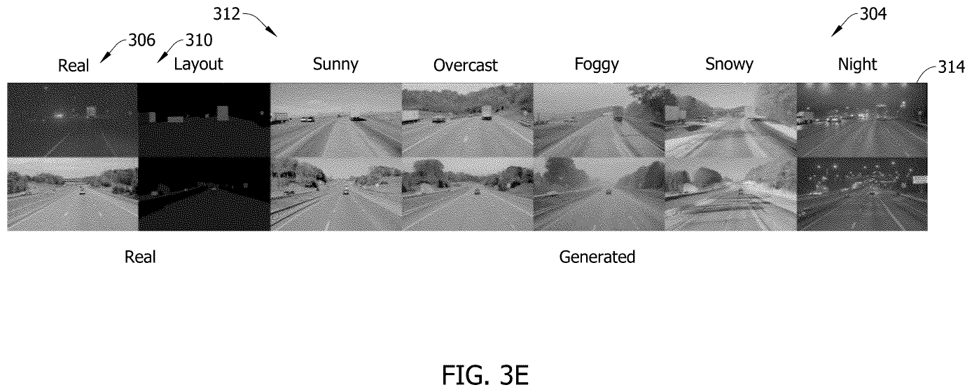

FIGS. 3A-3E show an example simulation generation computing device 300. FIG. 3A is a schematic diagram of simulation generation computing device 300. FIG. 3B is a schematic diagram of an example generation module 302 of simulation generation computing device 300. FIG. 3C is a schematic diagram showing a scene in a real-world or realistic simulated dataset of an environment in which autonomous vehicle 100 could operate. As used herein, a real-world dataset refers to a dataset acquired from a real-world environment. A real-world dataset may be acquired by sensors of autonomous vehicles, and real-world data are typically represented in an ego's view, where the ego refers to the autonomous vehicle acquiring the data. A realistic simulated dataset is a simulated dataset having simulated data that mimic the realistic representation in a real-world dataset and are also represented in an ego's view. As used herein, realistic simulated datasets are also referred to as simulated datasets. Simulated data may be referred to as synthetic data or generated data, as opposed to real-world data. FIG. 3D shows examples of frames 304 in a real-world dataset 306, an agent layout 308, a control layout 310, and a simulated dataset 312 in generation of simulated dataset 312, where frames in a column are at the same time instance. FIG. 3E show examples of frames 304 of simulated dataset 312 with different environments 314, where frames of a row are at the same time instance.

In the example embodiment, real-world dataset 306 or realistic simulated dataset 312 are organized in scenarios or scenes 316 (see FIG. 3C). A scene 316 lasts for a period of time, e.g., several seconds or minutes, and includes frames 304 arranged temporally. Each frame 304 includes an environment 314 in which autonomous vehicle is operating. Frame 304 also includes roads 318 and objects 320. Objects 320 include actors 322 and/or signs such as road signs. Actors 322 may be vehicles, cyclists, or pedestrians. The positions and/or velocity of actor 322 may change from frame to frame.

In the example embodiment, simulation generation computing device 300 includes generation module 302 and a sample evaluation module 326 (see FIG. 3A). Generation module 302 is configured to generate simulated dataset 312 based on one or more frames 304 of real-world dataset 306. Generation module 302 includes a control layout generation machine learning model 325 (see FIG. 3B), such as CtRL-Sim described in detail in Examples. Control layout generation machine learning model 325 is configured to generate control layouts 310 for controlling the layouts of the scenes in the simulated datasets.

In the depicted embodiment, in generating simulated dataset 312, one or more frames 304 of a real-world dataset 306 are input into generation module 302 (see FIG. 3B). Frame 304 is segmented, and roads 318 and objects 320 including actors 322 are detected. An initial control layout 310-i is provided. Control layout 310 shows roads and actors 322 in ego's view. An initial agent layout 308 is also generated based on the segmentation and detection. Agent layout 308 includes layout or states of agents 330 in a map 332. An agent is used to control the behavior of an individual actor in the environment, such as controlling positions, velocities, acceleration, jerk, and/or other properties of the actor from frame to frame. The map may be an HD map and depicts lanes. The map may be in a top-down view. For example, agent layout 308 depicts lanes, and actors 322 at corresponding lanes and positions in the lanes in map 332, along with other states of the actors 322.

In the example embodiment, initial agent layout 308 is input into control layout generation machine learning model 325, which is configured to output a sequence of agent layouts 308 based on initial agent layout 308. An example control layout generation machine learning model 325 includes one or more transformer networks. Control layout generation machine learning model 325 includes agents 330, each configured to control or manipulate the behavior of corresponding actor 322. For example, actor 1 322-1 is a semi-truck, and agent-1 330 controls the movement of semi-truck 322-1 in scene 316.

In the example embodiment, the outputs of control layout generation machine learning model 325 are a sequence of agent layouts 308 in temporal frames, each frame of agent layout 308 representing agents' states, e.g., positioning, velocity, and/or other properties of actor 322 in the map, at the corresponding time point in scene 316. For example, scene 316 last 10 s and includes 100 frames at an interval of 100 ms between neighboring frames. Initial agent layout 308 is at time 0. The output from control layout generation machine learning model 325 is a 10-second sequence of frames of agent layout 308. At time 0.1 s, agent layout 308 represents agents' states in map 332 at time point of 0.1 s from the beginning of scene 316.

In the example embodiment, output agent layouts 308 may be augmented by control layout generation machine learning model 325. Although the same actors 322 remain in agent layouts, the behavior of actors 322 may be changed or controlled by agents 330 for actors 322. Control layout generation machine learning model 325 is configured to generate augmented agent layouts 308 different from initial agent layout 308 by tilting return-to-go 334. Return-to-go 334 is a measure of performance on certain tasks by an actor 322. For example, when driving on the road, likelihood of colliding with other objects on the road is a measure of the driving performance of actor 322. Return-to-go 334 may include a sum of rewards of actor 322 during the entire length of scene 316. Return-to-go 334 may be adjusted or tilted to generate diverse datasets, which may include more accident-prone or less-accident prone scenes. For example, augmented agent layout 308 may simulate various behavior of one or more agents on the road (see FIG. 3D), such as cutting in or out of lanes, crossing lanes, or dangerous behaviors. Augmenting agent layouts directly in control layout generation machine learning model 325 is advantageous in manipulating actors directly to mimic various behavior of actors, thereby enabling the testing of capabilities of autonomy computing system 200 under a myriad of scenes.

In the example embodiment, sequences of agent layouts 308 are transformed into sequences of control layouts 310 for generating realistic simulated data. Agent layouts 308 are in a different view, such as a top-down view, from control layout 310, which is in an ego's view. Further, control layouts include environment 314. In one example, agent layout 308 represents a layout of lanes, and positioning and velocities of agents 330 in the map, may include numbers representing the positions and/or velocities of agents and the map such as lane boundaries. Coordinate transformations are applied to transform positions of agents 330 from the coordinates in agent layout 308 to positions in control layout 310. Further, color blocks may be used to draw the positions of agents 330 and the road.

In the example embodiment, generation module 302 further includes a diffusion machine learning model 328 configured to generate simulated data based on sequences 335 of control layouts 310. In one example, the simulated data include a scene having frames of realistic images 338, and are generated based on one sequence 335 of control layouts 310. A first frame of the simulated data is generated based on initial control layout C₀ in sequence 335 and a text prompt 336 describing environment 314. Text prompt 336 is a string of texts describing environment 314, such as weather conditions, visibility, and/or road conditions. A sequence of frames or images in realistic scenes 316 are generated based on the first frame and sequence 335 of control layouts 310.

In the example embodiment, diffusion machine learning model 328 is configured to augment simulated datasets 312 by varying environments of simulated data. For example, output realistic scenes 316 may be augmented by adjusting text prompts 336.

Systems and methods described herein are advantageous in increasing the amount of simulated data by augmenting sequences of control layouts and/or environments. In the depicted example shown in FIG. 3B, four sequences 335 of control layouts 310 are generated based on one frame in a real-world scene. Each sequence 335 of control layouts 310 is used to generate one scene in simulated dataset 312. For each sequence 335, environment 314 of scene 316 is augmented into four different environments, such as daytime with an overcast weather, daytime with a foggy condition, daytime with a snowy condition, and nighttime with a clear weather. As a result, 16 scenes 316 are generated. The numbers depicted are for illustration purposes only. Any number of augmentations may be implemented, using the systems and methods described herein.

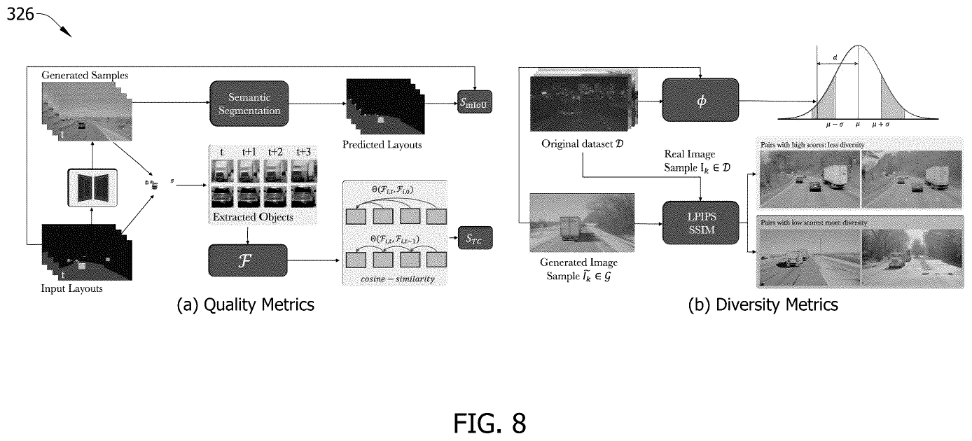

In the example embodiments, simulated dataset 312 is sampled and evaluated by sample evaluation module 326 (see FIG. 3A, and also see FIG. 8, described later). A diverse, quality simulated dataset that includes samples in simulated dataset 312 meeting criteria for a quality score and/or a diversity score are retained and output for developing autonomous vehicles 100.

In the example embodiments, sample evaluation module 326 is configured to sample and evaluate simulated datasets 312. Sample evaluation module 326 retrieves samples in simulated datasets 312, or sample scenes in simulated datasets 312. A quality score for each sample is determined in comparison with real-world dataset 306. The quality score may include a frame-based score of each sample. The frame-based score represents the consistency of objects in the sample in comparison with real-world dataset 306. In one example, semantic objects are segmented from samples. A mean intersection to union (mIoU) score of multiple classes of objects is determined. An IoU is a metric for detection of an object by measuring the overlap between a predicted bounding box of the object and a ground truth bounding box of the object. An mIoU is a metric for detection of multiple classes of objects by measuring the mean of the overlaps or intersections of the multiple classes of objects. Because objects move in time, in measuring the frame-based score, a frame of a sample at time point t is compared with a frame of control layout Cₜ at the corresponding time point t among control layouts C_{0:T}, where control layouts C_{0:T} are generated as control layout progressing in time from the initial time point 0 to the end time point T, based on real-world dataset 306.

In the example embodiment, a quality score may also include a temporal consistency score for each sample. The temporal consistency score is a metric representing consistency of the sample across temporal frames. A sample scene 316 is arranged in a temporal series of frames 304 (see FIG. 3C). Features may be extracted from the sample. A temporal consistency score may include one or more similarity metrics among features from frames. To evaluate scene stability and long-term consistency, the temporal consistency score includes a stability similarity metric measuring the similarity of features between neighboring frames for evaluating stability of scene 316, and a long-term similarity metric measuring the similarity of features of a frame at a time point t compared to a reference frame, such as the initial frame at the time point 0, for evaluating the long-term consistency of scene 316. Other frame between the time period of (0, T] may selected as the reference frame. The temporal consistency score may be a sum of the stability similarity metrics of frames 304 and the long-term similarity metrics of frames 304. In some embodiments, the temporal consistency is a weighted sum of the stability similarity metrics and the long-term similarity metrics, where the weights for the stability similarity metrics and the long-term similarity metrics may be pre-defined or user defined.

In the example embodiment, the quality score is a weighted sum of the frame-based quality score and the temporal consistency score. The weights for the frame-based quality score and the temporal consistency score may be pre-defined or user defined.

In the example embodiment, the simulated dataset is filtered to generate a quality simulated dataset 312-q, by retaining samples that meet a criterion of the quality score as quality samples in quality simulated dataset 312-q. A diversity score is determined on the retained samples, in comparison with real-world dataset 306. In one example, features are extracted from scenes in quality simulated dataset 312-q and real-world dataset 306. Features may be represented by feature vectors. The distribution of the features in quality simulated dataset 312 and the distribution of features in real-world dataset 306 are compared to determine the diversity score of quality simulated dataset 312. An example diversity score is a Mahalanobis distance based on mean and covariance in the distributions of features in quality simulated dataset 312 and real-world dataset 306. Diverse samples may be selected based on the Mahalanobis distance. A smaller Mahalanobis distance indicates that quality simulated dataset 312 is a closer but less diverse representation of real-world dataset 306. Quality, diverse samples may be selected as having the Mahalanobis distances in a middle range between a lower threshold, such as 2σ, and a higher threshold, such as 3σ, where σ is a measure of the deviation between quality simulated dataset 31-q and real-world dataset 306.

In the example embodiment, additionally or alternatively, perceptual similarity metrics may be determined as metrics that measure the diversity between simulated dataset 312 and real-world dataset 306. Diverse samples may be selected as having perceptual similarity metrics above a threshold, which indicate the samples are dissimilar or diverse from real-world dataset 306.

In the example embodiment, diverse, quality simulated dataset 312 is obtained by retaining samples in quality simulated dataset 312-q that meet criteria on diversity score. Diverse, quality simulated dataset 312-dq is output for developing autonomous vehicles.

Simulated datasets 312 simulated by generation module 302 are described for illustration purposes only. Systems and methods of generating diverse, quality simulated datasets based on a quality score and/or a diversity score, as described herein, may be applied to simulated data acquired from any sources, such as simulated datasets from a database or an online simulated data bank, or generated with any mechanisms, such as other data simulation mechanisms. Any simulated datasets may be sampled and evaluated by sample evaluation module 326. Any combination of metrics and scores described herein may be used to evaluate a simulated dataset. For example, only one or more quality score is used, or only one or more diversity score is used. In computing a quality score, the metrics may be in any combination. In computing a diversity score, the metrics may be in any combination. If a real-world dataset is unavailable for computing a metric, one or more scenes or one or more frames of a scene in the simulated dataset may be selected as a reference dataset in the place of the real-world dataset in computing metrics that compare samples of the simulated dataset with the real-world dataset. If a real-world dataset used to generate the simulated dataset is available, the real-world dataset is the reference dataset.

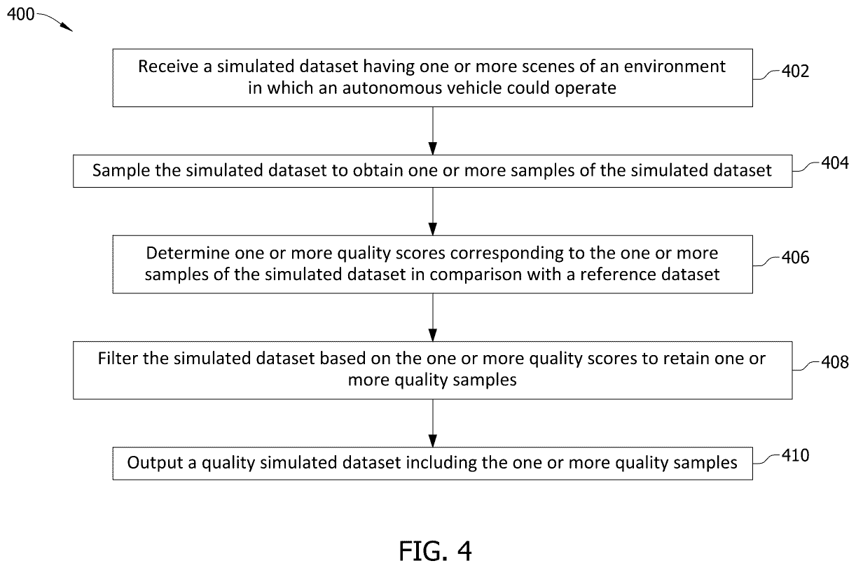

FIG. 4 is a flow chart of an example method 400. In the example embodiment, method 400 includes receiving 402 a simulated dataset having one or more scenes of an environment in which an autonomous vehicle could operate. Method 400 also includes sampling 404 the simulated dataset to obtain one or more samples of the simulated dataset. Method 400 further includes determining 406 one or more quality scores corresponding to the one or more samples of the simulated dataset in comparison with a reference dataset. In addition, method 400 includes filtering 408 the simulated dataset based on the one or more quality scores to retain one or more quality samples, and outputting 410 a quality simulated dataset including the one or more quality samples. In some embodiments, one or more diversity scores of the quality samples may be determined. The quality samples may be filtered based on the one or more diversity scores to obtain diverse, quality samples. A diverse, quality simulated dataset including the diverse, quality samples may be output for developing autonomy computing system 200 of autonomous vehicle 100. In one example, simulated datasets are generated using control layout generation machine learning model 325 and/or diffusion machine learning model 328. Simulated datasets may be augmented by varying control layouts 310 and/or varying environments of the simulated data.

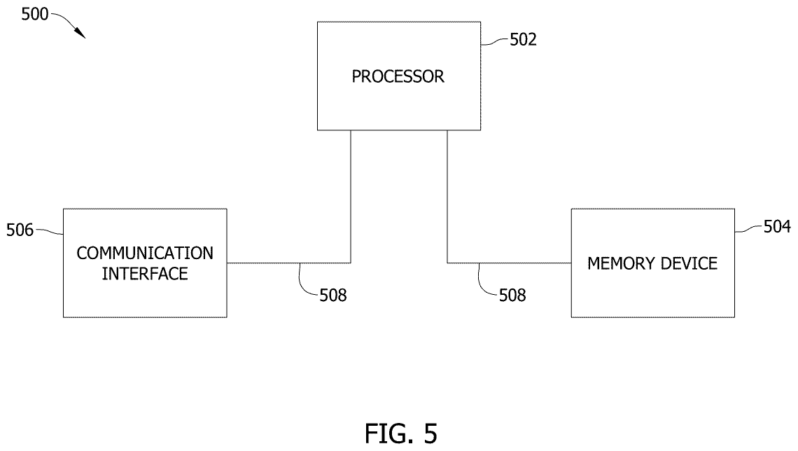

FIG. 5 is a block diagram of an example computing device 500. Autonomy computing system 200 may be implemented with one or more computing devices 500. In the example embodiment, computing device 500 includes a processor 502 and a memory device 504. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 may be programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

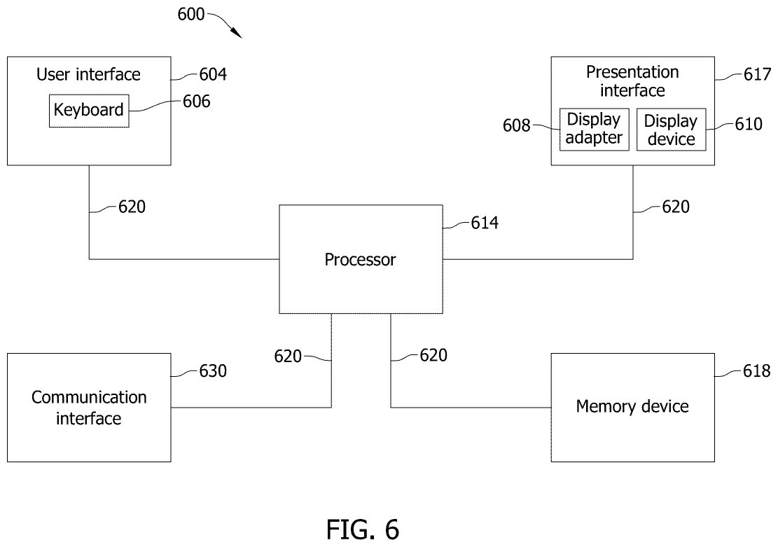

Simulation generation computing device 300 described herein may be any suitable computing device 600 and software implemented therein. FIG. 6 is a block diagram of an example user computing device 600. In the example embodiment, computing device 600 includes a user interface 604 that receives at least one input from a user. User interface 604 may include a keyboard 606 that enables the user to input pertinent information. User interface 604 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the example embodiment, computing device 600 includes a presentation interface 617 that presents information, such as input events and/or validation results, to the user. Presentation interface 617 may also include a display adapter 608 that is coupled to at least one display device 610. More specifically, in the example embodiment, display device 610 may be a visual display device, such as a cathode ray tube (CRT), a liquid crystal display (LCD), a light-emitting diode (LED) display, and/or an “electronic ink” display. Alternatively, presentation interface 617 may include an audio output device (e.g., an audio adapter and/or a speaker) and/or a printer.

Computing device 600 also includes a processor 614 and a memory device 618. Processor 614 is coupled to user interface 604, presentation interface 617, and memory device 618 via a system bus 620. In the example embodiment, processor 614 communicates with the user, such as by prompting the user via presentation interface 617 and/or by receiving user inputs via user interface 604. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are for illustration purposes only, and thus are not intended to limit in any way the definition and/or meaning of the term “processor.”

In the example embodiment, memory device 618 includes one or more devices that enable information, such as executable instructions and/or other data, to be stored and retrieved. Moreover, memory device 618 includes one or more computer readable media, such as, without limitation, dynamic random access memory (DRAM), static random access memory (SRAM), a solid state disk, and/or a hard disk. In the example embodiment, memory device 618 stores, without limitation, application source code, application object code, configuration data, additional input events, application states, assertion statements, validation results, and/or any other type of data. Computing device 600, in the example embodiment, may also include a communication interface 630 that is coupled to processor 614 via system bus 620. Moreover, communication interface 630 is communicatively coupled to data acquisition devices.

In the example embodiment, processor 614 may be programmed by encoding an operation using one or more executable instructions and providing the executable instructions in memory device 618. In the example embodiment, processor 614 is programmed to select a plurality of measurements that are received from data acquisition devices.

In operation, a computer executes computer-executable instructions embodied in one or more computer-executable components stored on one or more computer-readable media to implement aspects of the invention described and/or illustrated herein. The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

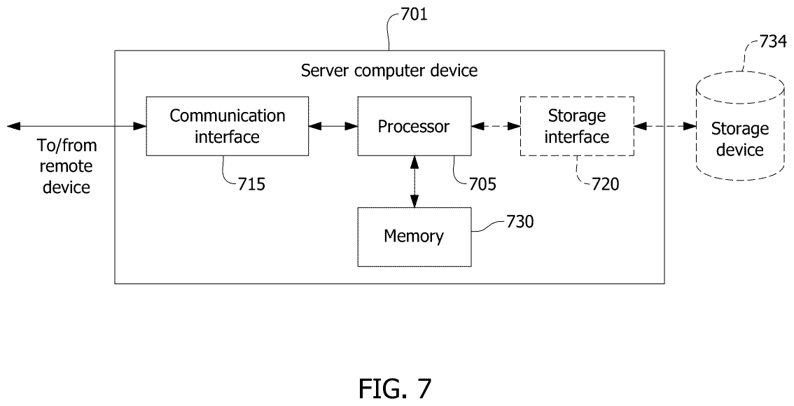

FIG. 7 illustrates an example configuration of a server computer device 701 such as simulation generation computing device 300. Server computer device 701 also includes a processor 705 for executing instructions. Instructions may be stored in a memory area 730, for example. Processor 705 may include one or more processing units (e.g., in a multi-core configuration).

Processor 705 is operatively coupled to a communication interface 715 such that server computer device 701 is capable of communicating with a remote device or another server computer device 701. For example, communication interface 715 may receive data from system 12, via the Internet.

Processor 705 may also be operatively coupled to a storage device 734. Storage device 734 is any computer-operated hardware suitable for storing and/or retrieving data. In some embodiments, storage device 734 is integrated in server computer device 701. For example, server computer device 701 may include one or more hard disk drives as storage device 734. In other embodiments, storage device 734 is external to server computer device 701 and may be accessed by a plurality of server computer devices 701. For example, storage device 734 may include multiple storage units such as hard disks and/or solid state disks in a redundant array of independent disks (RAID) configuration. storage device 734 may include a storage area network (SAN) and/or a network attached storage (NAS) system.

In some embodiments, processor 705 is operatively coupled to storage device 734 via a storage interface 720. Storage interface 720 is any component capable of providing processor 705 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 734.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

### EXAMPLES

### Example 1

The demand for extensive datasets to train computer vision models on large, dynamic outdoor scenes for autonomous driving has limited the advancement of vision-based systems. Acquiring annotated real-world data is costly, time-consuming, and often lacks rare events and complex scenarios critical for safety applications. Synthetic data offers a promising alternative by enabling the generation of diverse, controlled scenarios, including hard-to-capture edge cases. However, the domain gap between real-world and synthetic data remains a significant challenge, affecting model performance in real-world conditions. Recent advancements in diffusion-based generative models provide a potential solution by enhancing the realism of synthetic data, thus bridging some of this gap.

This work involves the use of generative video diffusion models to create simulated environments that meet these data requirements, ultimately enhancing monocular object detection. In particular, a scene-layout-conditioned video diffusion model is developed that generates novel scenarios that adhere to traffic regulations. The scene layouts are derived from the true distribution of possible scenarios, with mechanisms to adjust scene complexity as needed. This work will use a data validation strategy that enables effective resampling and pruning of low-quality data during training and generation, allowing for the use of today's imperfect generation models. The approach described herein, particularly for infrequent object classes, yields a performance improvement of 4.7% in object detection accuracy.

### 1. Introduction

Autonomous driving research has made significant progress in recent years, driven by the development of sophisticated machine learning models. However, the success of learned vision models heavily relies on the availability of large, diverse, and high-quality datasets. Moreover, it requires expensive manual annotations. Data augmentation techniques, such as random transformations, cropping, color jitter, and geometric distortions, have been widely used to expand datasets and improve model robustness. Although these techniques can improve generalization by exposing models to variations of existing data, they are generally limited in their ability to produce truly novel and diverse scenarios that reflect real-world complexity.

To address these challenges, generative methods may be highly beneficial. Diffusion models have emerged as a promising approach for creating realistic synthetic data by progressively refining noise toward a target distribution. This method has proven effective across a range of applications, including image and video generation, image inpainting, and data augmentation. Additionally, advancements in control mechanisms, such as ControlNet, enable layout-conditioned diffusion generation. By controlling the synthetic data generation process through bounding boxes, segmentation masks, and other layout constraints, these techniques facilitate large-scale generation of data and corresponding ground truth pairs without the need for additional annotations. In autonomous driving, different methods show that conditioned generated data may be effectively leveraged for downstream tasks such as object detection and tracking.

Despite their potential, diffusion models come with certain limitations. One of the primary challenges lies in their inherent randomness, which may lead to miss rates due to the random sampling of noise from a distribution. This may result in hallucination, inconsistency with the input conditions, as well as temporal inconsistencies for long video generation. Various approaches have been proposed to address these issues. However, failure cases may still occur, making the direct utilization of the raw generated data unsuitable for downstream object detection tasks. Common metrics for assessing the quality of generated images and videos, such as Fréchet Inception Distance (FID) and Fréchet Video Distance (FVD), measure the distance between distributions at the dataset level and are not suitable for evaluating the quality of individual generated images. Additionally, Structural Similarity Index (SSIM) and Learned Perceptual Image Patch Similarity (LPIPS), often used to assess visual coherence and perceptual similarity, are also limited to be used as direct quality metrics for layout-guided generated samples with diverse backgrounds and object styles. Therefore, developing effective data validation and pruning strategies for downstream tasks, such as training object detection models, remains an open challenge.

This work devises a scenario-conditioned generative video approach to provide a large corpus of training data. To this end, scene layouts will be generated using an offline reinforcement learning simulation approach CtRL-Sim. The method will be prompted with priors from the dataset and the scenarios will be altered from simple trajectories following a lead vehicle to complex adversarial behavior through a tilting mechanism. The generated scenarios are projected into the image space and use a control mechanism to guide the video generation model in producing realistic camera video sequences. The generated data is then validated and pruned by first assessing the quality of each sample using object and background-based quality metrics to ensure that both the objects and the environments in the simulation resemble real-world conditions as closely as possible and are consistent over the course of the generated sequences. Subsequently, the simulated data is evaluated with the original training domain sample distribution to select the samples to increase the training dataset diversity. The method is validated using the Mono-RCNN approach alongside temporal-consistent StreamPETR, observing an improvement in monocular 3D object detection accuracy of 2.96%, compared to the data augmentation method MixUp3D as a baseline.

In summary, the following contributions are made:
A controllable scenario generation approach is provided, which combines scenario layout generation and conditioned diffusion model to generate high-quality and temporal consistent image sequences of realistic and diverse driving scenarios.
A data validation method is provided, which measures the diversity and video consistency of scene objects to select informative samples, both offline and online, for learning vision models.
Through dataset evaluation, the data validation strategy may effectively incorporate generated data into existing dataset and significantly enhance the performance of monocular 3D object detection models.

### 2. Related Work

Monocular 3D Object Detection. Monocular 3D Object Detection has been explored extensively in computer vision. Existing work can be divided into two categories: image-only methods and methods that incorporate additional information, such as LiDAR and radar. In the first category, methods like Mono-RCNN and Deep3Dbox extend 2D detectors by leveraging geometric relationship between 2D and 3D to infer depth, while other approaches like M3D-RPN, MonoDETR, and MonoCD incorporate depth estimation networks to improve localization accuracy. Additionally, encoding the scene layouts in the BEV space has been explored both in image and LiDAR-based methods, trading off height information for computational efficiency. Approaches like SOLOFusion and StreamPETR further enhance performance by ensuring temporal consistency across frames, which stabilizes depth estimates in dynamic environments. To further improve model robustness, various data augmentation techniques have been explored, such as random crop, horizontal flip, photometric distortion, affine transformations, and intensity-based augmentation. Copy-Paste Augmentation has proven to be a simple and effective method for enhancing data diversity. MonoLSS proposes MixUp3D, which enriches 3D sample diversity by adding physical constraints to the traditional 2D MixUp method. MonoSample takes occlusion relationships into account and enforcing strict constraints to preserve scene realism. GRAMO integrates geometric consistency into copy-paste operations based on perspective projection principles.

Image and Video Diffusion. Image and Video Diffusion has enhanced the synthesis of high-resolution photorealistic images and videos, starting from generative adversarial networks (GANs) and likelihood-based methods. More recently, autoregressive diffusion-based models have emerged as a promising approach to achieve high-quality and diverse synthesis results. These novel approaches have also been adapted to video generation achieving high-quality results, enabling the control of the generation through text, image, or camera position. In autonomous driving, diffusion-based approaches have been exploited as world simulators, enabling control over image and video creation through layout conditions, such as bounding boxes and lane structures in both image and BEV spaces, as well as through ego-actions used as additional control signals. Additionally, world models leverage diffusion methods to generate realistic synthetic sequences from world embeddings, with a focus on simulating and predicting future world observations.

Generative Data Augmentation. Generative Data Augmentation has investigated the use of synthetic datasets to improve the performance of down-stream tasks such as object detection, depth estimation, and tracking. For instance, DreamDA synthesizes diverse data for image classification by reversing a diffusion process. Extending this concept, approaches like DatasetDM generate a variety of synthetic images with annotations for object-centric detection tasks, while leveraging diffusion-based inpainting to augment backgrounds, enhancing robustness in 2D object detection. Similarly, for open vocabulary 2D object detection, it augments both foreground and background elements. NeRFmentation applies neural radiance fields to augment views within a sequence, aiding monocular depth estimation, although it is limited to resimulating previously captured scenes. Despite these advancements, generative methods often encounter challenges in producing coherent novel views of a scene, especially when dynamic actors are involved or for expansive, unbounded urban settings. To address this, this work provides a novel simulation approach that incorporates layout conditioning with tilted scenarios, providing high-quality samples through necessary quality filtering. The method described herein also augments available training scenarios by including agents that adhere to traffic regulations with novel trajectories beyond the training data distribution, as well as a mechanism for creating rare collision samples typically absent in standard driving datasets.

### 3. DiffMentation

DiffMentation is a novel training data generation pipeline for vision models. Illustrated in FIG. 3B, diverse driving scenarios are generated from an initial recorded real-world frame, and are subsequently produced into realistic novel views exploiting a layout-guided video diffusion model. Afterwards, low-quality and redundant samples are automatically pruned with a set of training-based quality and diversity metrics to create a well distributed training dataset. The full training procedure is detailed in Sec. 5 of this Example.

FIG. 3B is a schematic diagram showing the overview of scenario and layout-conditioned video generation. CtRL-Sim simulates multiple scene rollouts

$${\{ \text{?} \}}_{i = 1}^{N}$$

by modifying the return-to-go Gₜ given an initial real-world scene [symbol] ₀. It then exploits a Text-to-Video Diffusion block including ControlNet, Text-to-Image and Image-to-Video models to generate diverse realistic videos using

$${\{ {\text{?}}_{0 : T}^{i} \}}_{i = 1}^{N}$$

different textual prompts Cₜₑₓₜ (e.g., time of the day, weather conditions, etc.).

Scenario Generation. As a first process, reactive and controllable driving scenarios are generated using CtRL-Sim which relies on the physics-enhanced Nocturne environment to ensure the physical realism of generated agent motions. Given an initial scene composed of agents' states and the contextual HD map [symbol] ₀=(S₀, m), CtRL-Sim learns a behavior simulation policy using a return-conditioned autoregressive multi-agent transformer model. Specifically, the learned joint distribution in this process is formulated as

$${p}_{θ} ( {A}_{t} , {G}_{t} \vert {S}_{t} , {S}_{G} , m ) = {π}_{θ} ( {A}_{t} \vert {S}_{t} , {S}_{G} , {G}_{t} , m ) \times {p}_{θ} ( {G}_{t} \vert {S}_{t} , {S}_{G} , m ) , \qquad ( 1 )$$

where Aᵢ and Sᵢ are the joint actions and states of all agents, respectively, S_{G} are the goal states of all agents,

$${G}_{t} = {\sum }_{{t}^{′} = t}^{T} {r}_{{t}^{′}}$$

is the return-to-go or all agents, and m is the HD map. At inference time, tilting the return-to-go distribution towards desired behavioral values, allows it to realistically alter the behavior of the agents surrounding the ego vehicle. The final output of this process is an alternative scene rollout [symbol] for all agents \tilde{S}_{0:T}, given the same initial joint state in the ground-truth scene.

Layout Generation. The simulated scene [symbol] , generated by the behavioral simulator, includes HD maps m and the temporal state \tilde{S}_{0:T}, of N₀ agents

$$\tilde{𝒪} = {\{ {\tilde{o}}_{i} \}}_{i = 1}^{{N}_{0}} ,$$

where each actor õᵢ is characterized by its sequence of states across time frames t∈[0,T].

The simulated representation is rendered into image space, forming a sequence of control layouts

$${C}_{0 : T} = ( {õ}_{0 : T}^{box} , {m}_{0 : T}^{seg} ) .$$

Each control layout Cₜ at time t∈[0,T] includes the projected, color-coded bounding boxes

$${õ}_{t}^{box}$$

of visible objects [symbol] ^{vis} and a static road segmentation map m^{seg} rendered from the camera view.

These control layouts serve as guide for generating realistic frames with a fine-tuned ControlNet, in conjunction with Text-to-Image (T2I) and Image-to-Video diffusion models, as illustrated in FIG. 3B.

First-frame Generation. The control condition C₀ at the initial state t=0, along with the text prompt Cₜₑₓₜ, directs the generation of the first reference frame [symbol] ₀ by combining the fine-tuned image ControlNet and Text-to-Image (T2I)φ(⋅) architectures, that is

$$\text{?} = φ ( {C}_{0} , {C}_{text} ) . \qquad ( 2 )$$

In this process, a set of text prompts Cₜₑₓₜ enable the generation of diverse weather conditions, locations, and backgrounds, expanding the available pool of real data through diffusion augmentation.

Video Generation. The first reference frame, along with the entire sequence of control layouts C_{0:T}, is then input into the fine-tuned video ControlNet and Image-to-Video diffusion model γ(⋅) to generate the full video sequence [symbol] _{0:T}, that is

$$\text{?} = γ ( {C}_{0 : T} , \text{?} ) . \qquad ( 3 )$$

Synthetic Data Validation and Resampling. Next the subset of synthetic data that best balances samples of the latent real data distribution are selected, and data that does not accurately resemble real-world conditions is excluded. To this end, the generated video data based on quality score and diversity score as described below are resampled.

Generative Quality Score. FIG. 8 is a schematic diagram of an example method of synthetic data validation and selection. Quality and diversity scores are combined to filter generated samples for training downstream models (e.g., 3D Object Detection). The quality score combines spatial alignment (S_{mIoU}) and temporal consistency (S_{TC}) through cosine similarity, while the diversity score measures perceptual differences using similarity metrics (LPIPS and SSIM) and Mahalanobis distance (d) between generated and real images.

To evaluate the quality of synthetic samples, a frame-based score for individual images and a temporal consistency score for sequences are used. For single-frame quality, a segmentation mIoU self-consistent score S_{mIoU} is used to evaluate whether the generation of the images has been correctly guided by the conditioning layouts with object instance bounding boxes õ^{box} as well as road segments m^{seg}. Specifically, the self-consistency score for frame [symbol] ₜ is

$${S}_{mIoU} = \frac{1}{{N}_{c} \cdot ( T + 1 )} {\sum }_{t = 0}^{T} {\sum }_{j = 1}^{{N}_{c}} IoU ( {M}_{j , t} , {C}_{j , t} ) , \qquad ( 4 )$$

where N_{c} represents the number of classes (including object instance classes as well as the road class), T+1 the length of the generated sequence, and M_{j,t} the extracted segmentation map of the generated sample for class j at t-th frame. This score assesses the model capability to precisely generate specific object classes in the right spatial positions. To extract the segmentation map M_{j,t} of the generated image, the Semantic Segment Anything (SSA) is leveraged due to its zero-shot generalization capability.

Cross-frame temporal instance consistency is assessed by measuring per-object consistency across frames in the generated sequence. Specifically, for each object mask

$${õ}_{i}^{box}$$

in the control condition layouts Cₜ, the visual features [symbol] _{i,t} are extracted from each generated frame [symbol] ₜ at time step t. Next, the cosine similarity Θ of the extracted features between the current frame [symbol] ₜ and the previous frame [symbol] ₜ₋₁ is calculated.

$$Θ ( {ℱ}_{i , t} , {ℱ}_{i , t - 1} ) = \frac{{ℱ}_{i , t} \cdot {ℱ}_{i , t - 1}}{‖ {ℱ}_{i , t} ‖ ‖ {ℱ}_{i , t - 1} ‖} . \qquad ( 5 )$$

To evaluate scene stability and long-term consistency, the instance patch similarity score Θ( [symbol] _{i,t}, [symbol] _{i,0}) between current frame [symbol] ₜ and initial frame [symbol] ₀ is computed. The consistency score for the generated sequence [symbol] _{0:T} is then the mean score of all objects õ^{box} across all the frames

$${S}_{TC} = \frac{1}{2 {N}_{o} T} {\sum }_{t = 1}^{T} {\sum }_{i = 0}^{{N}_{o}} ( Θ ( {ℱ}_{i , t} , {ℱ}_{i , t - 1} ) + Θ ( {ℱ}_{i , t} , {ℱ}_{i , t - 1} ) ) , \qquad ( 6 )$$

where Nₒ denotes the total number of objects in the sequence. The final quality score is then computed by the weighted sum of the frame-based score and temporal instance consistency score

$${S}_{quality} = {α}_{1} \cdot {S}_{mIoU} + {α}_{2} \cdot {S}_{TC} . \qquad ( 7 )$$

The generated sequences are ranked based on the quality score S_{quality}, selecting those with the highest scores.

Diversity Score. After filtering the generated dataset [symbol] to retain only high-quality samples, the dataset is resampled again to maximize diversity relative to the original dataset of real image sequences [symbol] . First, the mean [symbol] and covariance [symbol] of the feature representations extracted from the real dataset [symbol] are computed. This is done by passing each image sequence [symbol] ∈ [symbol] through the feature extractor to obtain its feature vector φ [symbol] ) The mean [symbol] is the average of these feature vectors φ [symbol] ), and the covariance [symbol] captures the variance and correlations between the features

$${\sum }_{𝒟} = \frac{1}{\vert 𝒟 \vert} \text{?} ( ϕ ( \text{?} ) - {μ}_{𝒟} ) {( ϕ ( \text{?} ) - {μ}_{𝒟} )}^{T} . \qquad ( 8 )$$

Next, for each generated image sequence [symbol] ₖ∈ [symbol] , the feature vector φ( [symbol] ₖ) is extracted and its distance to the distribution of the real dataset [symbol] is calculated. Doing this requires the computation of the Mahalanobis distance between the feature vector of the generated image and the real dataset distribution, which is given as

$$d ( \text{?} , 𝒟 ) = \sqrt{{( ϕ ( \text{?} ) - {μ}_{𝒟} )}^{T} {\sum }_{𝒟}^{- 1} ( ϕ ( \text{?} ) - {μ}_{𝒟} )} \qquad ( 9 )$$

This distance quantifies how far each generated image sequence is from the distribution of the real dataset in feature space. A smaller distance indicates that the generated sequence is closer to the real dataset distribution but with less diversity. In contrast, a larger distance suggests lower quality but greater diversity. To balance both quality and diversity, only the image sequences whose distances lie between 2σ and 3σ are selected, ensuring that the generated sequences are of good quality while preserving sufficient diversity.

For the generated image sequences with layouts replayed from real scenes, perceptual similarity metrics such as the Learned Perceptual Image Patch Similarity (LPIPS) and the Structural Similarity Index (SSIM) between pairs of real and generated image sequences are computed. These metrics quantify the visual difference between the real and generated sequences. To promote greater visual diversity, the image sequences with worse LPIPS and SSIM scores are selected as they indicate more perceptual difference and greater diversity between the original and generated samples, that is

$${S}_{diversity} = {β}_{1} \cdot LPIPS ( \text{?} , \text{?} ) + {β}_{2} \cdot \frac{1}{SSIM ( \text{?} , \text{?} )} \qquad ( 10 )$$

### 4. Datasets

A real-world dataset was collected and annotated, which allows for the training and evaluation of the approach on diverse highway and urban scenes. Below describes both the real-world and the generated datasets in detail.

Real-World Dataset. For the monocular object detection task, a long-range dataset was captured with a semi-truck-mounted sensor module, incorporating multiple synchronized sensors. The primary camera, an OnSemi AR0820 model, features a ½-inch CMOS sensor capturing raw data in RCCB format at 15 Hz and a resolution of 3848×2168 pixels. The dataset spans a range of highway and suburban scenes across Texas, New Mexico, and Virginia, recorded under varied daytime and weather conditions. It includes 16207 sequential images with manually annotated 2D and 3D bounding boxes at 5 Hz and 10 Hz frequencies, covering four object classes: Truck, Passenger-Car, Person, and TrafficSign, with annotation ranges up to 400 meters. The dataset contains 7821 samples for training and 8386 samples for validation, corresponding to the original dataset splits for both sets, before augmentation with generated data.

Generated Dataset. The original dataset is extended using the diffusion-based method, DiffMentation, to enlarge the pool of training data. The generated dataset includes three subsets based on the source of control layouts: original (real-world) scenarios, simulated scenarios using CtRL-Sim, and scenarios from holdout external (real-world) scenarios. For the original scenarios, control layouts are extracted directly from the real dataset annotations, D, and generate diverse frames that mainly differ in background and agent appearances due to the inherent randomness of the Stable Diffusion model. This background and semantic augmentation provide diversity to the training set. For the CtRL-Sim scenarios, simulations are initialized with original agents at t=0. By modifying the reward-to-go function, long-tail, safety-critical scenarios (e.g., cut-in scenarios) that are difficult to capture in real-world recordings are simulated. For the external scenarios, control layouts from additional real-world annotations are incorporated, extending the dataset with new, unseen scenarios by leveraging external data sources (e.g., publicly available datasets). Overall, 21140, 9900 and 44130 samples are generated for each scenario source, resulting in an expansion of the original dataset by approximately 10 times, from 7821 to a total of 82991 samples.

### 5. Experiments

In this section, the DiffMentation approach described herein for 3D object detection is evaluated. The first process is to describe the experimental setup, the evaluation criteria, and the implementation details. Following this, a qualitative analysis of the method is performed, followed by a quantitative comparison with other 3D object detection augmentation techniques, benchmarking on both non-temporal and temporal 3D object detection models. Finally, an ablation study is performed that validates the design choices made for the method.

Evaluation Metrics. To assess the effectiveness of the method, the standard 3D object detection metrics are used. These include Mean Average Precision (mAP) and NuScenes Detection (ND) Score, which combines mAP with other auxiliary metrics (mATE, mASE, mAOE, mAVE, and mAAE) to provide a comprehensive evaluation of 3D object detection performance, capturing the precision, accuracy in positioning, scale estimation, and orientation of detected objects in 3D space. Metrics are calculated for a detection range of 0-100 m, with true positives defined by a distance threshold of less than 2 m.

Implementation Details. This approach is implemented based on Stable Diffusion (SD) and the publicly available pre-trained 1.5 billion parameters Text-to-Image (T2I) model. Both the SD backbone and the image auto-encoder are frozen, thereby training the ControlNet model to condition the generated images based on the provided control layouts. ControlNet is fine-tuned from the pre-trained SD weights for a total of 100000 steps, with a batch size of 10 and a learning rate of 1·e⁻⁵, at a resolution of 1024×576.

For training text prompts, descriptive captions for n randomly sampled frames across videos are generated using the pretrained LLaVA model, applying majority voting to ensure consistency across frames. The LLaVA model is equipped with a specific context prompt to produce outputs in JSON format, providing specific captions (e.g., time of the day, weather, etc.) that populate a structured template for generating training text prompts.

Following the Text-to-Image training setup, a pretrained Stable Video Diffusion model is leveraged and a ControlNet architecture is fine-tuned in order to generate video sequences. ControlNet is fine-tuned over 200000 steps with a batch size of 2 and a learning rate of 2·e⁻⁵, generating 10-frame sequences at a resolution of 1024×576.

Both the Text-to-Image, φ(⋅), and Image-to-Video diffusion model, γ(⋅), are trained on a system equipped with 8 NVIDIA A100 GPUs, each with 80 GB of memory.

Mono-RCNN Training. A non-temporal single-frame monocamera 3D object detection model, Mono-RCNN, is trained using the internal dataset, with images at a resolution of (1952, 1088). The model is trained using the AdamW optimizer, with a batch size of 24, over 20 epochs, and validated every 2. The base learning rate is set to 2·e⁻⁴, employing a linear warm-up followed by cosine annealing scheduler. The training process was carried out on a single NVIDIA 80G-A100 GPU for all the experiments.

StreamPETR Training. A temporal-consistent monocamera 3D object detection model, an adapted version of StreamPETR for single-camera input, is trained on an experimental long-range test dataset. Images are resized to a resolution of (704, 256) to balance computational efficiency and detection accuracy. The model is trained using the AdamW optimizer with a batch size of 48 over 70 epochs, with validation every 10 epochs to track performance. The base learning rate is set to 6·e⁻⁵, following a linear warm-up phase to stabilize initial training, then a cosine annealing scheduler for efficient convergence. Training was conducted on 4 NVIDIA 80G-A100 GPUs, leveraging their high memory capacity to support large batch sizes and the temporal consistency required for robust 3D object detection. These configurations ensure a solid foundation for training on challenging datasets.

### 5.1. Experimental Findings

The following reports the qualitative and quantitative findings using the experimental setup described above. In addition, an ablation study is performed in order to validate the contributions of each module of the approach described herein.

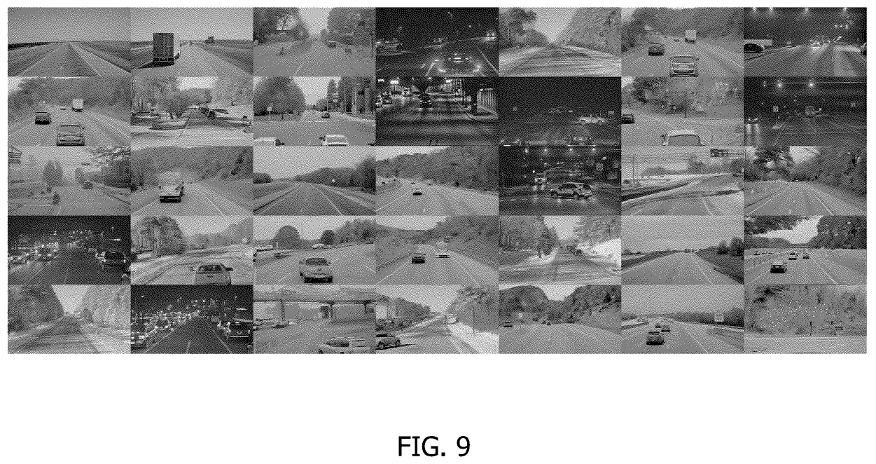

Qualitative Results. The effectiveness of the filtering approach is qualitatively confirmed by reporting examples of high-quality image and video generations with top scores in S_{quality} and S_{diversity}, in FIG. 9. Shown in FIG. 9 are randomly selected generative samples of the dataset, illustrating that the method described herein is capable of generating high-quality, diverse training data. This includes the capability to generate tilted scenarios, which allows for the simulation of an agent stuck perpendicular to the center of an intersection during a green light period at night (row 3, column 5)—this scenario is not present in the data observed by the model. These examples highlight how the method described herein is able to carefully generate and select high-quality and diverse samples, emphasizing semantic and structural quality, temporal consistency across frames, and higher diversity compared to the original real samples.

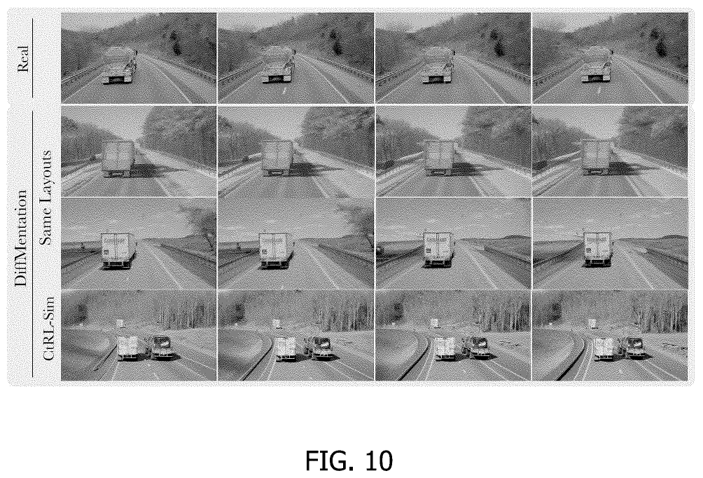

Additionally, FIG. 10 presents examples of generated sequences based on the same layouts as the original training scenarios, serving as background and semantic augmentations (e.g., modifying agent styles, colors, etc.). Synthetic data is generated using annotated real data with the same or RL-generated layouts shown for different rows. With diverse text prompts, backgrounds may be changed and realistic sequences generated (time x-axis). Integrating CtRL-Sim, the method described herein produces diverse and realistic data with rare edge cases of adversary driving vehicles. It also showcases simulated sequences generated by CtRL-Sim, which enable modifications to agent trajectories and rare long-tail behaviors (e.g., cut-in scenarios).

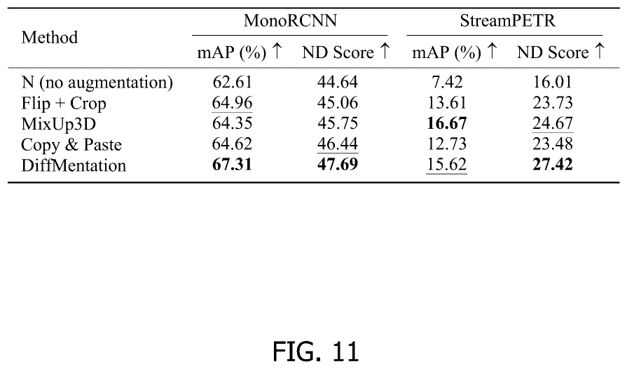

Quantitative Results. The quality and consistency of the approach described herein is demonstrated in the table shown in FIG. 11, by evaluating its effectiveness in 3D object detection performance compared to a baseline method without augmentation and existing augmentation techniques, including standard Flip+Crop, MixUp3D, and Copy & Paste methods. As shown in FIG. 11, The effect of the video-generated scenarios on the experimental long-range test dataset (8386 samples, see text) is evaluated. Existing augmentation techniques are compared, such as MixUp3D and copy & pasting of GT objects. Note, traditional data augmentation methods only allow for recombination of available training data samples. On the other hand, DiffMentation may extend the training corpus by integrating generated samples adding truly novel scenarios. The approach described herein outperforms the baseline methods, showing improvements in the MonoRCNN by 4.7% in mAP metric, and the adapted single-view StreamPETR model by 11.41 in ND Score compared to the baseline without augmentation, respectively. This demonstrates the effectiveness of generated and filtered data in improving 3D Object Detection performance. The best results in each category are in bold and the second best are underlined. All approaches are evaluated on two 3D object detection models: Mono-RCNN and StreamPETR, an object centric temporal model. For StreamPETR, the model is adapted to operate in single-camera mode.

The method described herein expands the dataset size by over 50% of its original volume, resulting in improved performance across both mAP and ND scores. Specifically, it achieves a 4.7% increase in mAP for Mono-RCNN, along with ND score gains of 2.12 for Mono-RCNN, compared to the no-augmentation-baseline method trained on the real-only dataset. Furthermore, the approach described herein outperforms traditional augmentation techniques, such as random flip, crop, MixUp3D, and copy-paste, by approximately ~2% in mAP and ~1 in ND Score. This confirms the ability of DiffMentation to generate and select high-quality data and brings benefits to monocular 3D Object Detection task. For StreamPETR, all approaches show relatively lower performance, likely because StreamPETR was originally designed for multi-view setups. The method described herein achieves comparable mean AP to the MixUp3D method, trailing by only 1%. However, the method described herein achieves the highest ND score among all approaches of 27.42. This suggests that this approach may generate temporally consistent data, making it particularly effective in scenarios where temporal coherence are essential.

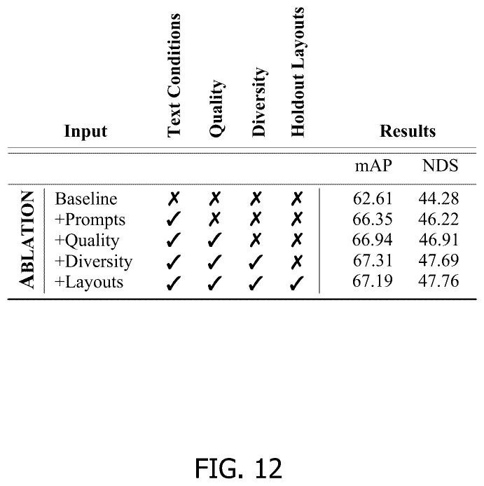

Ablation Experiments. In this Section and the table shown in FIG. 12, a systematical ablation study is reported which validates the contributions of each module within the DiffMentation approach. As shown in FIG. 12, for MonoRCNN, the effects of different layout generation strategies for synthetic data are evaluated. Each scenario generation module represents a method for creating diverse layouts across generated videos.

The first process begins with no augmentation and it subsequently adds as first ablation randomly generated samples based on scene layouts within the training data distribution. Adding generated samples itself boosts by 3.74% in mAP score. Next, higher quality samples are systematically filtered and improve total performance by 0.59%. Following, higher diversity is ensured and the generated samples are compared to the source data by adding samples with higher difference and sufficient quality metrics, improving results further by 0.37%. Adding external scenarios from a holdout dataset with 6294 samples does not increase performance further as the distribution of scenarios matches the one from the source training dataset.

### 6. Discussion and Conclusion

In this work, layout-conditioned generative data is investigated as a source of training data for 3D object detection. Specifically, a method is provided that integrates a behavioral simulator, CtRL-Sim, with a diffusion model to generate realistic video scenarios starting from control layouts and text prompts. By combining these elements, the approach enables the synthesis of diverse and simulated driving environments, offering a rich and scalable source of alternative scenarios for training. This, in turn, enhances the robustness, adaptability, and generalization capability of 3D object detection models.

To further improve training with realistic and diverse samples, a detailed and systematic methodology is developed for validating and selecting generated data based on quality and diversity scores, S_{quality} and S_{diversity}. The results demonstrate that augmenting the original real-world dataset with strategically selected synthetic samples significantly improves performance in the downstream task of 3D object detection. Specifically, the approach achieves with the Mono-RCNN method a 2.97% improvement over the MixUp3D method and a 4.7% improvement compared to the baseline without augmentation. These findings underscore the value of leveraging high-quality, diverse synthetic data to address challenges such as data imbalance, rare event modeling, and domain adaptation.

Supporting multi-view video generation and data validation may be provided, thereby enabling more accurate modeling of complex scenes from diverse perspectives, as well as advanced multi-view object detection capabilities. This could be a first process towards a fully data-driven closed-loop simulator, allowing for the generation of sensor data not only for perception tasks but the entire autonomy stack-ultimately with the goal of replacing the function of test vehicles for capture and validation entirely in simulation.

### Example 2

### 1. Additional Implementation Details

This section provides implementation details of image and video diffusion model training, as well as the specific implementations employed for 3D object detection training.

First-frame Generation. For first frame generation, the DDPM noise scheduler is utilized during training, while for inference, 50 steps with the DDIM scheduler are employed. The learning rate is maintained constant. Further, Classifier-Free Guidance (CFG) is applied with a 10% dropout rate on text prompt conditioning during training and use a CFG scale of 3.0 during inference. Additionally, the ControlNet conditioning scale is set to 3.0 for conditioning layouts.

To generate realistic first frames, specific negative prompts are employed tailored to the scene type. For day scenes, the negative prompts include: “a photo unrealistic and blurry, worst quality, low quality, normal quality, painting, drawing, sketch, cartoon, anime, render, morbid, mutated.” For night scenes, the negative prompts are: “a photo unrealistic and blurry, worst quality, low quality, normal quality, bright colors, warm tones, sunny, cheerful, daylight, overly bright, overly saturated, colorful, vibrant, cartoonish, anime, pastel, soft focus, exaggerated, render, painting, drawing, sketch, morbid, mutated, unnatural color.” Positive prompts follow the template: “An high-quality realistic driving scene during the { }, in a { } weather,” where the placeholders represent the time of day and the weather conditions, respectively.

Video Generation. For video generation, the pre-trained UNet model weights from stabilityai/stable-video-diffusion-img2vid-xt-1-11 are used. The Euler scheduler was used as a noise scheduler, and the learning rate scheduler is kept constant. To ensure the model strictly adheres to the first-frame conditioning, the CFG-Scale is set to 1 during inference. Additionally, since the dataset is labeled at varying FPS, the frequency is incorporated as an additional embedding in the ControlNet during both training and inference.

Synthetic Data Validation and Resampling. To subsample the generated dataset, the strategy is outlined as follows. For samples with replicated layouts generated from different prompts, the diversity score S_{diversity} is added to the quality score S_{quality} to obtain a final score. The samples are then sorted by this total score and the best ones are selected based on the desired mix ratio. For samples with holdout layouts or those generated by CtRL-Sim, the samples are first sorted by their quality score S_{quality} and the best-quality samples are selected. Then, the [symbol] ( [symbol] ₖ, [symbol] ) metric is used to identify diverse samples with good quality, selecting those whose distance falls between 2σ and 3σ. These samples are then combined with the qualitative samples. For calculating the quality score, α₁ and α₂ are both set to 1, while for diversity score β₁=2 and β₂=1.

MonoRCNN. The Mono-RCNN method for the 3D object detection task is built on a custom implementation of the Faster R-CNN architecture, integrated with both 2D and 3D object detection capabilities. The network uses ResNet-18 as the backbone for feature extraction, with a Region Proposal Network (RPN) for generating proposals and a specialized Rol head to predict and optimize 3D bounding boxes for different classes. The AdamW optimizer is used with a learning rate of 2e⁻⁴ for all experiments, while adopting a linear warmup and cosine annealing learning rate scheduler. All the experiments are trained for a total of 20 epochs.

### 2. Additional Qualitative Evaluation

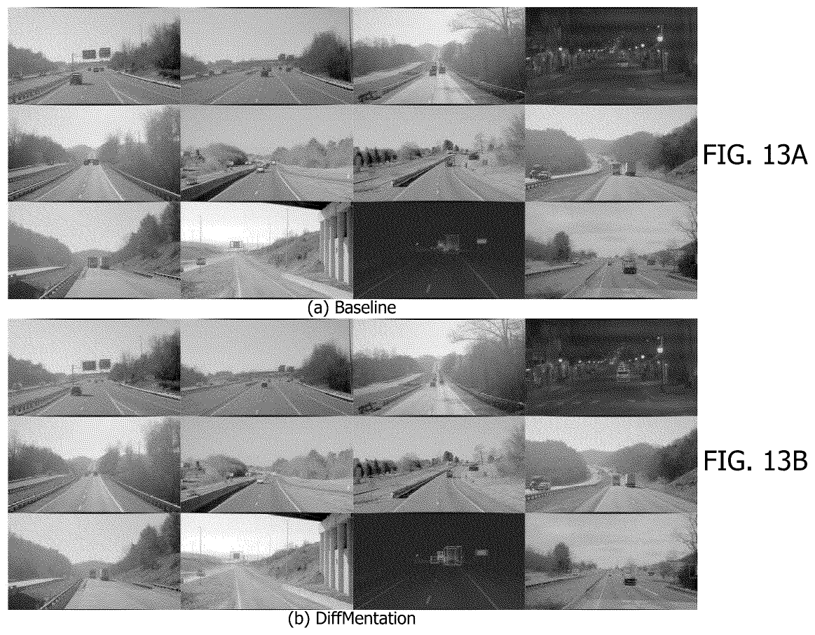

In this section, qualitative results are presented to illustrate visually the effectiveness of the method to provide valuable data for the training of a monocular 3D object detection approach. To qualitatively assess the performance of the MonoRCNN model, detection results are provided on a variety of test samples in FIGS. 13A and 13B. The red 3D boxes in FIG. 13A represent detections from the baseline method without augmentation (N), while the green boxes in FIG. 13B represent detections from the DiffMentation method. The method described herein demonstrates improved performance, particularly in detecting distant objects, handling occlusions, and recognizing underrepresented classes, such as trucks. The visual results demonstrate that the model identifies objects. Comparing the method to the baseline detection model without augmentation, it exceeds its performance consistently especially for long distances, challenging yaw angles and relatively more seldom classes as trucks.

### 3. Additional Quantitative Evaluation

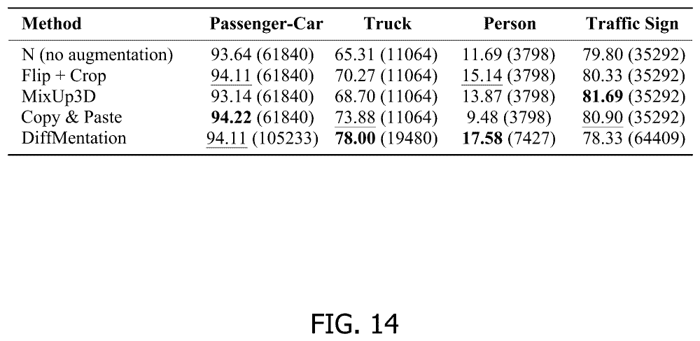

In this section, detailed ablation studies are presented and additional experimental results to analyze the effectiveness of the approach described herein. Specifically, the impact of different augmentation strategies, control layouts, and dataset sizes on 3D object detection performance are evaluated. The results are summarized in tables in FIGS. 14-16, each of which highlights specific aspects of the method described herein.

### 3.1. Class-Wise Performance Analysis

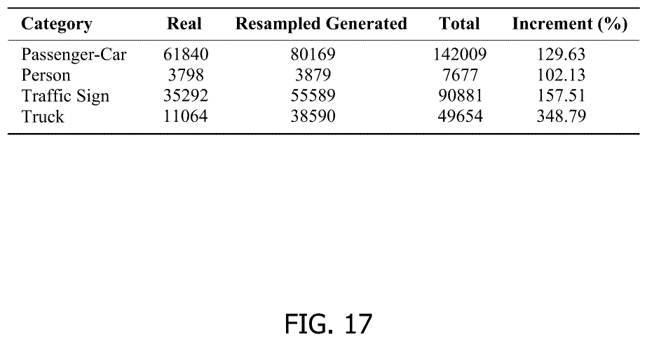

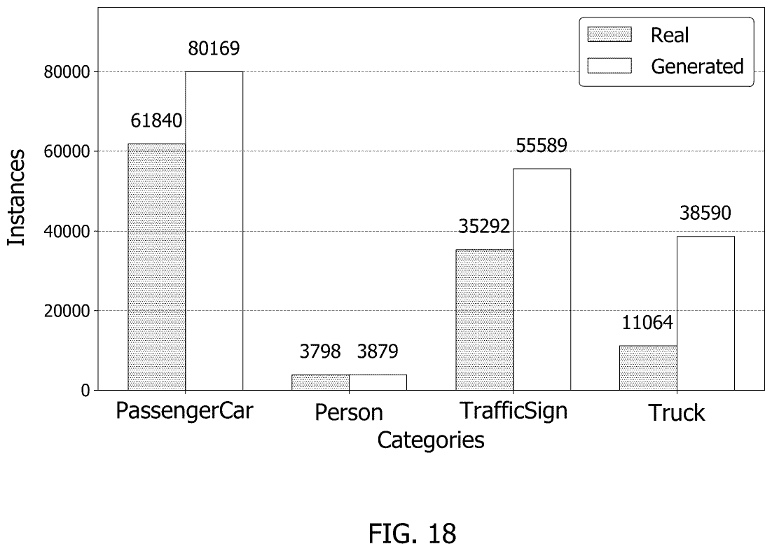

The results in the table of FIG. 14 highlight the class-wise performance of MonoRCNN with the method against various augmentation techniques. The number of class instances used for training in each method is shown in parentheses next to the corresponding mAP value. Best results are in bold, and second-best are underlined. DiffMentation achieves the highest mAP for the under-represented Truck (78.00%) and Person (17.58%) classes, significantly outperforming other baselines. This reflects the effectiveness of DiffMentation in addressing data scarcity, as it nearly doubles the instance counts for these classes, as shown in FIG. 17 and FIG. 18 described later in Sec. 4 of this Example. Notably, this improvement is achieved without compromising performance for the major classes, such as Passenger-Car, with mAP differences of less than 0.1% compared to the baseline methods. However, it lags behind the MixUp3D method by approximately 3% for the Traffic Sign class, likely due to the diffusion model's difficulty in rendering accurate and coherent text.

The numbers in parentheses indicate unique instance counts for training. Note, that previous state of the art is unable to enrich the database with unique instance, but only recombines existing instances.

### 3.2. Ablation Study on Layout Configurations

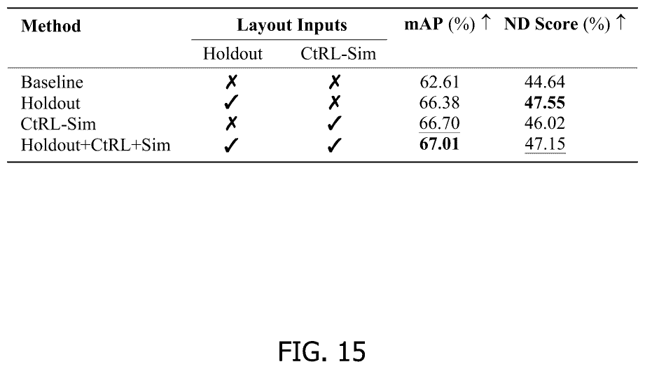

To evaluate the impact of different control layouts and the CtRL-Sim scenario simulation, ablation experiments are performed, summarized in FIG. 15. The table in FIG. 15 shows overall mAP and ND Score for various layout configurations. Holdout and CtRL-Sim layouts are compared. Consistent filtering metrics and data ratios are used across all methods. Best results are in bold, and second-best are underlined. The experiments compare baseline performance with three layout configurations: Holdout (layouts from a distinct, annotated real-world distribution) and the CtRL-Sim, which is capable of generating entirely unseen scenarios. The table reports per-class mAP, overall mAP, and ND scores, highlighting the role of control layouts in enhancing dataset diversity and detection performance.

For the following ablation analysis, the fixed sampling approach is applied separately to two distinct generative dataset splits created using different layout configurations. These splits are then combined to form a large dataset.

The Baseline setup without augmentation performs the worst with a mAP of 62.61% and an ND Score of 44.64%, highlighting the importance of adding generated samples. The Holdout configuration, leveraging holdout layouts, achieves the highest ND Score (47.55%). Incorporating CtRL-Sim further enhances diversity, achieving the second-best mAP (66.70%). Finally, combining Holdout+CtRL-Sim yields the best overall mAP (67.01%).

### 3.3. Real and Generated Mixing Ratio

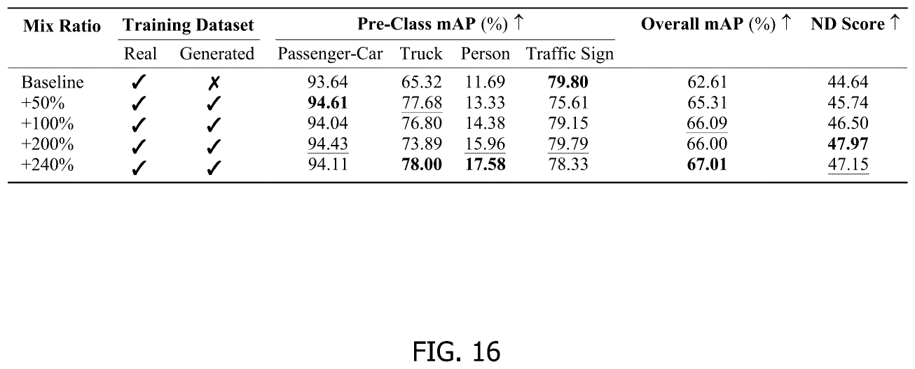

FIG. 16 is a table that explores the impact of varying the ratio of real and generated data on training performance. The table reports per-class mAP, overall mAP, and ND Score. Each configuration corresponds to a specific mix ratio, while keeping the layout and evaluation metrics consistent across experiments. Best results are in bold, and second-best are underlined. Scenarios are evaluated where 50%, 100%, 200% and 240% additional generated samples are added on top of the original real-world training dataset. This is compared to a baseline using only the real dataset without augmentation.

For this ablation analysis, a fixed sampling strategy was employed on the entire generated dataset from all layout sources (Holdout and CtRL-Sim). The results demonstrate how blending real and synthetic data influences both per-class and overall mAP, as well as ND scores. Specifically, the Baseline, using only real-world data, achieves the lowest overall mAP (62.61%) and ND Score (44.64%). Adding +50% generated data improves Passenger-Car mAP to the highest value (94.61%) and increases overall mAP to 65.31%. The +100% mix achieves a balanced improvement, with a strong overall mAP (66.09%) and consistent gains across most classes. At +200%, the ND Score rises to (47.97%) and Person mAP reaches 15.96%, showing benefits from higher diversity. Finally, +240% achieves the best overall mAP (67.01%), driven by significant improvements in under-represented classes like Truck (78.00%) and Person (17.58%), demonstrating the effectiveness of incorporating a larger proportion of generated data.

### 4. Additional Dataset Details

Understanding the composition of the dataset is crucial for evaluating the performance of augmentation techniques. The process begins with a real training dataset including 7821 samples, and through the approach described herein, generate 83670 additional samples expanding the original dataset by approximately a factor of 10. After applying quality and diversity sampling, a refined generated dataset is obtained containing 18860 samples, reaching a multiplying factor of roughly 2.4.

### 4.1. Class Dataset Statistics

The distribution of class instances in the real, refined generated datasets, as well as the total generated datasets, is summarized in FIGS. 17 and 18. This figure visualizes the class distribution of the real (gray) and refined generated (orange) datasets, highlighting the number of instances per class and the overall class statistics. As shown in the figure, generation balances the dataset with substantial improvement especially for underrepresented classes like Person and Truck, where the increase is 102.13% and 348.79%, respectively. This highlights the effectiveness of the generation process.

### 4.2 Dataset Visualization

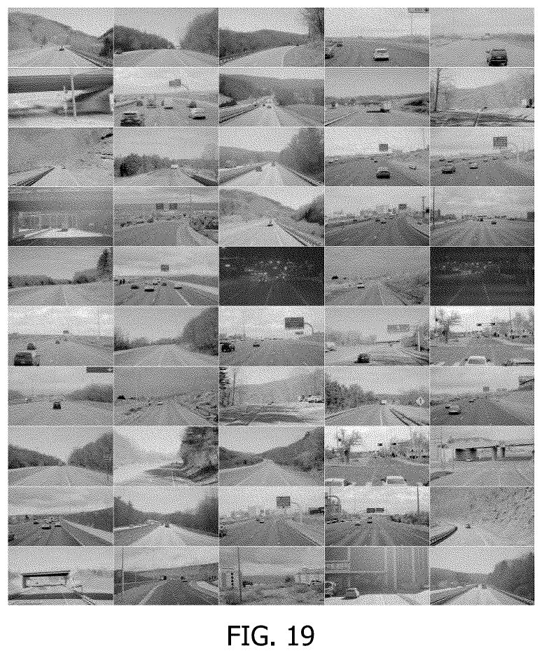

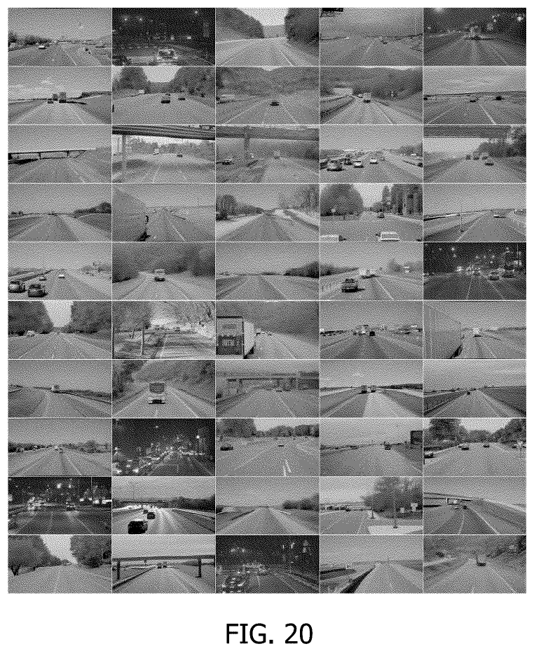

Visualization is provided of both the real-world and generated datasets to highlight their diversity and complementary nature. FIG. 19 and FIG. 20 show a selection of randomly sampled images from the real-world dataset and generated dataset, respectively, with various weather conditions, scene types, and the time of day. These visualizations emphasize the role of generated data in augmenting the real-world dataset to enrich training diversity and improve model robustness.

The generated dataset augments the real dataset by addressing underrepresented cases, such as rare classes, long-tail scenarios, and uncommon weather conditions (e.g., foggy/snowy or nighttime scenarios). Additionally, it broadens the diversity of the training data, introducing semantic variations—both background and foreground—that extend beyond the original real-world dataset.

Specifically, by leveraging CtRL-Sim, the simulation method is able to generate long-tail scenarios that are difficult to capture in real-world datasets, such as dangerous cut-ins and near-crashes and therefore particularly increase model performance, by introducing realization unseen in the outside world. These scenarios represent high-risk situations that are still plausible in real-world driving, but not readily available in traditional datasets. Therefore, this ability to simulate such complex situations enables more comprehensive training for 3D object detection, helping the model better to handle edge cases.

Overall, there is qualitative and quantitative confirmation that the augmented dataset covers a wide range of environmental conditions, rare events, and complex driving scenarios.

### 4.3. Generated Dataset Insights

This section describes the various factors influencing the generated dataset and analyze how specific aspects, such as weather conditions, times of day, and layout configurations, affect the diversity and complexity of the driving environments.

Weather Conditions and Time of Day. This part explores the impact of varying weather conditions and times of day on the generated dataset. A range of weather scenarios are simulated, including sunny, clear, foggy, and snowy conditions, to capture the environmental diversity that the model may encounter in real-world situations. Additionally, scenes are generated for two distinct times of day: daytime and nighttime, to assess the effects of lighting and visibility changes.

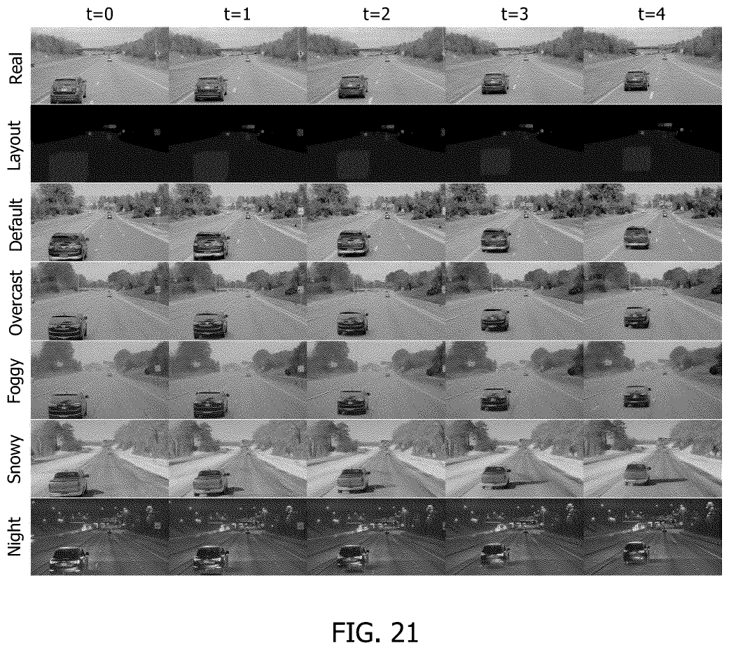

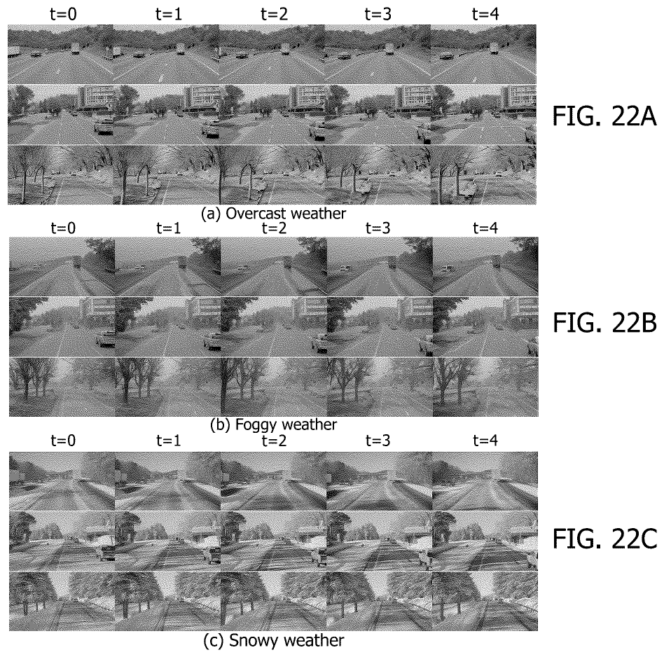

The images in FIG. 21 demonstrate how varying weather conditions and times of day affect the generated sequences over time. These changes include shifts in visibility, lighting, and road conditions, highlighting adaptation to diverse environments. The first row illustrates a real-world sequence with frames progressing from left to right over time. The second row depicts the corresponding control layouts used for generation, in this case, the real-world one. Subsequent rows showcase sequences under different weather conditions and lighting scenarios, demonstrating the diversity of the generated dataset. Additionally, FIGS. 22A-22C present diverse generated sequences over time, highlighting a variety of scenes and conditions, where realizations of the same layout conditioning are shown in (a) overcast (FIG. 22A), (b) foggy (FIG. 22B) and (c) snowy (FIG. 22C) weather.

An example technical effect of the methods, systems, and apparatus described herein includes at least one of: (a) evaluating simulated datasets based on a quality score and/or a diversity score, (b) generating quality simulated datasets by filtering simulated databases based on quality scores, (c) generating diverse, quality simulated datasets by filtering simulated databases based on quality scores and diversity scores, or (d) increasing the amount of simulated data by augmenting the control layouts and/or environments of the scenes.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware may be designed to implement the systems and methods based on the description herein.

When implemented in software, the disclosed functions may be embodied, or stored, as one or more instructions or code on or in memory. In the embodiments described herein, memory includes non-transitory computer-readable/machine-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A simulation generation computing device for developing an autonomy computing system of an autonomous vehicle, comprising at least one processor in communication with at least one memory device, the at least one processor programmed to:
receive a simulated dataset having one or more scenes of an environment in which an autonomous vehicle could operate;
sample the simulated dataset to obtain one or more samples of the simulated dataset;
determine one or more quality scores corresponding to the one or more samples of the simulated dataset in comparison with a reference dataset;
filter the simulated dataset based on the one or more quality scores to retain one or more quality samples; and
output a quality simulated dataset including the one or more quality samples.

2. The simulation generation computing device of claim 1, wherein the at least one processor is further programmed to:
determine the one or more quality scores by:
for each sample of the one or more samples of the simulated dataset,
determining a quality score of the each sample including a frame-based score of the each sample, the frame-based score representing consistency of objects in the each sample in comparison with the reference dataset.

3. The simulation generation computing device of claim 1, wherein the at least one processor is further programmed to:
determine the one or more quality scores by:
for each sample of the one or more samples of the simulated dataset,
determining a quality score of the each sample including a temporal consistency score of the each sample, the temporal consistency score representing consistency of the each sample across frames of the each sample.

4. The simulation generation computing device of claim 1, wherein the at least one processor is further programmed to:
determine the one or more quality scores by:
for each sample of the one or more samples of the simulated dataset,
determining a quality score of the each sample as a weighted sum of a frame-based score of the each sample and a temporal consistency score of the each sample.

5. The simulation generation computing device of claim 1, wherein the at least one processor is further programmed to:
determine one or more diversity scores corresponding to the one or more quality samples in comparison with the reference dataset;
filter the quality simulated dataset based on the one or more diversity scores to retain one or more diverse, quality samples; and
output a diverse, quality simulated dataset including the diverse, quality samples.

6. The simulation generation computing device of claim 5, wherein the at least one processor is further programmed to:
determine the one or more diversity scores by:
for each sample of the one or more quality samples,
determining a diversity score of the each sample based on distribution of features of the each sample and distribution of features of the reference dataset.

7. The simulation generation computing device of claim 5, wherein the at least one processor is further programmed to:
determine the one or more diversity scores by:
for each sample of the one or more quality samples,
determining a diversity score of the each sample based on a perceptual similarity metric between the each sample and the reference dataset.

8. The simulation generation computing device of claim 1, wherein the reference dataset is a real-world dataset, the at least one processor further programmed to:
generate the simulated dataset by:
generating an initial agent layout based on one or more frames of the real-world dataset, the initial agent layout representing a layout of one or more agents in a map of the environment, an agent of the one or more agents representing an actor in the environment;
generating, via a control layout generation machine learning model, a sequence of agent layouts based on the initial agent layout;
transforming the sequence of agent layouts to a sequence of control layouts, each control layout in the sequence of control layouts represented in an ego's view; and
generating, via a diffusion machine learning model, the simulated dataset including a realistic scene based on the sequence of control layouts and a text prompt describing the environment.

9. The simulation generation computing device of claim 8, wherein the at least one processor is further programmed to:
generate a plurality of sequences of augmented agent layouts by:
tilting a return-to-go of at least one of the one or more agents.

10. The simulation generation computing device of claim 8, wherein the at least one processor is further programmed to:
generate the simulated dataset by:
receiving a plurality of text prompts describing the environment; and
augmenting the realistic scene based on the plurality of text prompts.

11. One or more non-transitory machine-readable storage media for generating simulated datasets for developing an autonomy computing system of an autonomous vehicle, the one or more non-transitory machine-readable storage media comprising a plurality of instructions stored thereon that, in response to being executed, cause a system to:
receive a simulated dataset having one or more scenes of an environment in which an autonomous vehicle could operate;
sample the simulated dataset to obtain one or more samples of the simulated dataset;
determine one or more quality scores corresponding to the one or more samples of the simulated dataset in comparison with a reference dataset;
filter the simulated dataset based on the one or more quality scores to retain one or more quality samples; and
output a quality simulated dataset including the one or more quality samples.

12. The one or more non-transitory machine-readable storage media of claim 11, wherein the plurality of instructions further cause the system to:
determine the one or more quality scores by:
for each sample of the one or more samples of the simulated dataset,
determining a quality score of the each sample including a frame-based score of the each sample, the frame-based score representing consistency of objects in the each sample in comparison with the reference dataset.

13. The one or more non-transitory machine-readable storage media of claim 11, wherein the plurality of instructions further cause the system to:
determine the one or more quality scores by:
for each sample of the one or more samples of the simulated dataset,
determining a quality score of the each sample including a temporal consistency score of the each sample, the temporal consistency score representing consistency of the each sample across frames of the each sample.

14. The one or more non-transitory machine-readable storage media of claim 11, wherein the plurality of instructions further cause the system to:
determine the one or more quality scores by:
for each sample of the one or more samples of the simulated dataset,
determining a quality score of the each sample as a weighted sum of a frame-based score of the each sample and a temporal consistency score of the each sample.

15. The one or more non-transitory machine-readable storage media of claim 11, wherein the plurality of instructions further cause the system to:
determine one or more diversity scores corresponding to the one or more quality samples in comparison with the reference dataset;
filter the quality simulated dataset based on the one or more diversity scores to retain one or more diverse, quality samples; and
output a diverse, quality simulated dataset including the diverse, quality samples.

16. The one or more non-transitory machine-readable storage media of claim 15, wherein the plurality of instructions further cause the system to:
determine the one or more diversity scores by:
for each sample of the one or more quality samples,
determining a diversity score of the each sample based on distribution of features of the each sample and distribution of features of the reference dataset.

17. The one or more non-transitory machine-readable storage media of claim 15, wherein the plurality of instructions further cause the system to:
determine the one or more diversity scores by:
for each sample of the one or more quality samples,
determining a diversity score of the each sample based on a perceptual similarity metric between the each sample and the reference dataset.

18. The one or more non-transitory machine-readable storage media of claim 11, wherein the reference dataset is a real-world dataset, and the plurality of instructions further cause the system to:
generate the simulated dataset by:
generating an initial agent layout based on one or more frames of the real-world dataset, the initial agent layout representing a layout of one or more agents in a map of the environment, an agent of the one or more agents representing an actor in the environment;
generating, via a control layout generation machine learning model, a sequence of agent layouts based on the initial agent layout;
transforming the sequence of agent layouts to a sequence of control layouts, each control layout in the sequence of control layouts represented in an ego's view; and
generating, via a diffusion machine learning model, the simulated dataset including a realistic scene based on the sequence of control layouts and a text prompt describing the environment.

19. The one or more non-transitory machine-readable storage media of claim 18, wherein the plurality of instructions further cause the system to:
generate a plurality of sequences of augmented agent layouts by:
tilting a return-to-go of at least one of the one or more agents.

20. The one or more non-transitory machine-readable storage media of claim 18, wherein the plurality of instructions further cause the system to:
generate the simulated dataset by:
receiving a plurality of text prompts describing the environment; and
augmenting the realistic scene based on the plurality of text prompts.
